(19) United States
(12) Patent Application Publication
(10) Pub. No.: US 2004/0207619 A1
(43) Pub. Date: Oct. 21, 2004

(54) Energy recovering apparatus and method for plasma display panel

(75) Inventors: Jang Hwan Cho, Kumi-shi (KR); Won Sik Yoon, Kimhae-shi (KR); Seong Ho Kang, Daegu-kwangyeokshi (KR)

Correspondence Address: FLESHNER & KIM, LLP, P.O. Box 221200, Chantilly, VA, 20153-1200, US

(73) Assignee: LG ELECTRONICS INC.

(21) Appl. No.: 10/824,417

(22) Filed: Apr. 15, 2004

(30) Foreign Application Priority Data
Apr. 16, 2003 (KR) P2003-23990
Apr. 16, 2003 (KR) P2003-23989

(51) Int. Cl. G09G 5/00

(52) U.S. Cl. 345/212

(57) ABSTRACT

An energy recovering apparatus and method uses an inductor to recover an energy stored in a display capacitance. The recovered energy is reusable for driving a display device, preferably a plasma display. The energy recovery can be based on LC resource frequency or not based on such frequency.

### BACKGROUND OF THE INVENTION

1. Field of the Invention

This invention relates to an energy recovering apparatus and method for a plasma display panel, and more particularly to an energy recovering apparatus and method thereof.

2. Background of the Related Art

Recently, there has been developed various flat panel devices that are capable of reducing weight and bulk. Such flat panel display devices include a liquid crystal display (LCD), a field emission display (FED), a plasma display panel (PDP) and an electro-luminescence display (ELD), organic and inorganic EL, etc.

The PDP uses a gas discharge, and allows manufacture of a large-dimensional panel. The PDP typically includes three electrodes which is preferably driven with an AC voltage.

Referring to FIG. 1, a discharge cell of the conventional PDP preferably includes a first electrode 12Y and a second electrode 12Z provided on an upper substrate 10, and an address electrode 20X provided on a lower substrate 18.

On the upper substrate 10 provided preferably with the first electrode 12Y and the second electrode 12Z in parallel, an upper dielectric layer 14 and a protective film 16 of preferably MgO are disposed. Wall charges generated upon plasma discharge are preferably accumulated near the upper dielectric layer 14.

A lower dielectric layer 22 and barrier ribs 24 are preferably formed on the lower substrate 18 provided with the address electrode 20X. The surfaces of the lower dielectric layer 22 and the barrier ribs 24 are preferably coated with a fluorescent (e.g. phosphorous) material 26. The address electrode 20X is preferably formed in a direction crossing the first electrode 12Y and the second electrode 12Z. The barrier rib 24 is preferably formed in parallel to the address electrode 20X. Gas, preferably inactive gas, is provided in a discharge space defined between the upper and lower substrate 10 and 18 and the barrier rib 24. As can be appreciated, other layouts of the PDP structure is possible.

The PDP is preferably driven based on a number of sub-fields. In each sub-field interval, a light emission having a frequency proportional to a weighting value of a video data is conducted to provide a gray scale display. Each sub-field is divided into an initialization period, an address period, a sustain period and an erasure period.

The initialization period is generally a period for forming wall charges on the discharge cell. The address period is a period for generating a selective address discharge in accordance with, e.g., a logical value of the video data. The sustain period is a period for allowing a discharge cell in which the address discharge has been generated to sustain a discharge. The erasure period is a period for erasing a sustain discharge generated in the sustain period.

The address discharge and the sustain discharge of the PDP driven in the above manner requires a high voltage, e.g., more than hundreds of volts. Accordingly, an energy recovering apparatus is used for the purpose of minimizing a driving power required for the address discharge and the sustain discharge. The energy recovering apparatus recovers a voltage between the first electrode 12Y and the second electrode 12Z, to thereby use the recovered voltage as a driving voltage upon the next discharge.

Referring to FIG. 2, energy recovering apparatus 30 and 32 of the PDP having been suggested by U.S. Pat. No. 5,081,400 of Weber are symmetrically arranged with respect to each other with having a panel capacitor Cp there between. The panel capacitor Cp is an equivalent expression of a capacitance formed between the first electrode Y and the second electrode Y. The first energy recovering apparatus 30 applies a sustain pulse to the first electrode Y. The second energy recovering apparatus 32 operates alternately with respect to the first energy recovering apparatus 30 to thereby apply a sustain pulse to the second electrode Z. FIG. 3 is a timing diagram and a waveform diagram representing an on/off timing of switches in the first energy recovering apparatus and an output waveform of the panel capacitor. A detailed description can be found in this patent, and hence, a detailed explanation of the operation is omitted.

Such conventional energy recovering apparatus 30 and 32 require many circuit elements resulting in increased manufacturing cost. Further, power consumption is relatively large due to a conduction loss of a plurality of switches, an inductor, etc., on the current path.

FIG. 4 illustrates an energy recovering apparatus for a plasma display panel disclosed by U.S. Pat. No. 5,670,974 which includes a panel capacitor 40 equivalently representing a capacitance formed between a scanning electrode and a sustain electrode of the plasma display panel 1, and a charging/discharging circuit 2 and a voltage clamp circuit 3 connected in parallel with the panel capacitor Cp. The charging/discharging circuit 2 includes a coil 8 connected in parallel with the panel capacitor 40 of the panel 1 to re-charge a reverse polarity of a resonant current generated when the panel capacitor 40 is discharged, and two switches 12 and 13.

The switches 12 and 13 form a bi-directional switch with respect to the coil 8. One side of the panel capacitor 40 is connected, in series, to the two switches 12 and 13 formed from N-channel FET's controlled by different switch drive inputs IN5 and IN6 supplied to their respective gate terminals and reverse current blocking diodes 10 and 11 connected in series with the respective switches 12 and 13. Other side of the panel capacitor 40 is connected to one end of the parallel circuit having the coil 8 and a resistor 9. To the other end of the parallel circuit, the other terminal of the diodes 10 and 11 are connected commonly. The resistor 9 connected in parallel with the coil 8 of the charging/discharging circuit 2 is a damping resistor provided for the purpose of preventing an oscillation of a waveform.

The voltage clamp circuit 3 includes first to fourth switches 4, 5, 6 and 7, of which the first and third switches 4 and 6 are respectively connected between one of two terminals of the panel capacitor 40 and power source terminals GND and −VS while the second and fourth switches 5 and 7 are respectively connected between the other of the terminals of the panel capacitor 40 and the power source terminals GND and −VS. The first and second switches 4 and 5 are P-channel FET's, and the third and fourth switches 6 and 7 are N-channel FET's. The switches 4, 6 and the switches 5, 7 form the CMOS type circuit structures, respectively.

FIG. 5 is a waveform diagram representing drive voltage and drive current waveforms in the panel shown in FIG. 4. FIGS. 6A-6D illustrate the current path during time periods A-D of FIG. 5. A detailed description can be found in this patent, and hence, a detailed explanation of the operation is omitted.

The energy recovering apparatus suggested by U.S. Pat. No. 5,679,094 of NEC corporation requires an energy recovering circuit and a sustain circuit for each of the scanning electrode and the sustain electrode of the plasma display panel 1 to thereby cause a complex circuit configuration. Accordingly, it has a problem in that a manufacturing cost rises. Furthermore, power consumption is relative large due to the conduction loss of the switches.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

An object of the present invention is to provide an energy recovering apparatus and method thereof for a plasma display panel.

An object of the present invention is to minimize a conduction loss.

An object of the present invention is to simplify a circuit configuration.

In order to achieve these and other objects of the invention, an energy recovering apparatus of a plasma display panel according to one aspect of the present invention includes a plasma display panel; a voltage source for supplying a sustain voltage, via a single of switching device, to the panel; an inductor for recovering an energy stored in the panel by a resonance provided by itself and the panel and applying the recovered energy to the panel; and a switching circuit for forming a current path between the inductor and the panel.

In the energy recovering apparatus, the voltage source includes a first voltage source for charging the panel into a sustain voltage having a first polarity; and a second voltage source for charging the panel into a sustain voltage having a second polarity different from the first polarity.

The switching device includes a first switch for forming a current path between the first voltage source and the panel; and a second switch for forming a current path between the second voltage source and the panel.

Herein, the first switch forms a current path between the first voltage source and the panel in a period when a voltage of the panel is kept at the first polarity of sustain voltage.

The second switch forms a current path between the second voltage source and the panel in a period when a voltage of the panel is kept at the second polarity of sustain voltage.

The switching circuit includes third and fourth switches arranged, in parallel, between the inductor and the panel; a first diode connected between the third switch and a panel capacitor to shut off a backward current from the panel capacitor; and a second diode connected between the fourth switch and the panel capacitor to shut off a backward current from the fourth switch.

The third switch forms a current path between the inductor and the panel going by way of the first diode in a period when a voltage of the panel rises from the second polarity of sustain voltage into the first polarity of sustain voltage.

The fourth switch forms a current path between the inductor and the panel going by way of the second diode in a period when a voltage of the panel falls from the first polarity of sustain voltage into the second polarity of sustain voltage.

An energy recovering apparatus of a plasma display panel according to another aspect of the present invention includes a plasma display panel; a voltage source for charging the panel; an inductor for charging an energy from the voltage source during a period when a voltage of the panel is kept at a sustain voltage by means of the voltage source; and switching devices for shutting off a path between the panel and the voltage source in a state in which an energy has been charged in the inductor to derive an inverse voltage into the inductor and supplying the inverse voltage to the panel.

In the energy recovering apparatus, the inductor stores an energy recovered from the panel and supplies the derived inverse voltage to the panel.

The voltage source includes a first voltage source for charging the panel into a sustain voltage having a first polarity; and a second voltage source for charging the panel into a sustain voltage having a second polarity different from the first polarity.

The switching device includes a first switching device connected between the first voltage source and the panel; a second switching device connected between the second voltage source and the panel; third and fourth switching devices connected, in parallel, between the inductor and the panel; a first diode connected between the third switch and a panel capacitor to shut off a backward current from the panel capacitor; and a second diode connected between the third switch and the panel capacitor to shut off a backward current from the fourth switch.

The first switching device forms a path between the first voltage source and the panel in a period when a voltage of the panel is kept at the first polarity of sustain voltage, and shuts off said path between the first voltage source and the panel when a voltage of the panel falls from the first polarity of sustain voltage.

The second switching device forms a path between the second voltage source and the panel in a period when a voltage of the panel is kept at the second polarity of sustain voltage, and shuts off the path between the second voltage source and the panel when a voltage of the panel rises into the first polarity of sustain voltage.

The third switching device forms a path between the inductor and the panel in a period when a voltage of the panel is charged into the first polarity of sustain voltage in a state kept at the second polarity of sustain voltage.

The fourth switching device forms a path between the inductor and the panel in a period when a voltage of the panel is charged into the second polarity of sustain voltage in a state kept at the first polarity of sustain voltage.

An energy recovering method for a plasma display panel according to still another aspect of the present invention includes (A) charging a voltage from a voltage source into the panel via a single of switching device; and (B) recovering an energy stored in the panel with the aid of a resonance provided by an inductor and the panel and applying the recovered energy to the panel.

In the energy recovering method, step (A) includes charging a sustain voltage having a first polarity from a first voltage source into the panel; and charging a sustain voltage having a second polarity different from the first polarity supplied from a second voltage source into the panel.

Step (A) further includes forming a current path between the first voltage source and the panel using the first switch; and forming a current path between the second voltage source and the panel using the second switch.

The first switch forms a current path between the first voltage source and the panel in a period when a voltage of the panel is kept at the first polarity of sustain voltage.

The second switch forms a current path between the second voltage source and the panel in a period when a voltage of the panel is kept at the second polarity of sustain voltage.

Step (B) includes forming a current path between the inductor and the panel using the third switch; shutting off a backward current from the panel using a first diode connected between the third switch and the panel; forming a current path between the inductor and the panel using the fourth switch connected, in parallel, to the third switch; and shutting off a backward current from the fourth switch using a second diode connected between the fourth switch and the panel.

The third switch forms a current path between the inductor and the panel going by way of the first diode in a period when a voltage of the panel rises from the second polarity of sustain voltage into the first polarity of sustain voltage.

The fourth switch forms a current path between the inductor and the panel going by way of the second diode in a period when a voltage of the panel falls from the first polarity of sustain voltage into the second polarity of sustain voltage.

An energy recovering method for a plasma display panel according to still another aspect of the present invention includes (A) charging a voltage from a voltage source into the panel; (B) charging an energy from the voltage source into an inductor during a period when a voltage of the panel is kept at a sustain voltage by means of the voltage source; and (C) shutting off a path between the panel and the voltage source in a state in which an energy has been charged in the inductor using switching devices to derive an inverse voltage into the inductor and supplying said inverse voltage to the panel.

In the energy recovering method, the inductor stores an energy recovered from the panel and applies the derived inverse voltage to the panel.

Step (A) includes charging a sustain voltage having a first polarity from a first voltage source into the panel; and charging a sustain voltage having a second polarity different from the first polarity supplied from a second voltage source into the panel.

Step (A) further includes forming a current path between the first voltage source and the panel in a period when a voltage of the panel is kept at the first polarity of sustain voltage; and shutting off the path between the first voltage source and the panel when a voltage of the panel falls from the first polarity of sustain voltage.

Step (A) further includes forming a current path between the second voltage source and the panel in a period when a voltage of the panel is kept at the second polarity of sustain voltage; and shutting off the path between the second voltage source and the panel when a voltage of the panel rises into the first polarity of sustain voltage.

The energy recovering method further includes the step of forming a path between the inductor and the panel in a period when a voltage of the panel is charged into the first polarity of sustain voltage in a state kept at the second polarity of sustain voltage.

The energy recovering method further includes the step of forming a path between the inductor and the panel in a period when a voltage of the panel is charged into the second polarity of sustain voltage in a state kept at the first polarity of sustain voltage.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a perspective view representing a preferable structure of a plasma display panel;

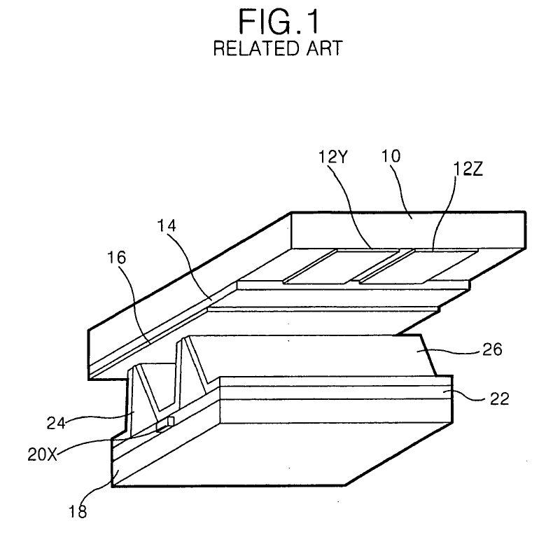

FIG. 2 is a circuit diagram of a conventional energy recovering apparatus;

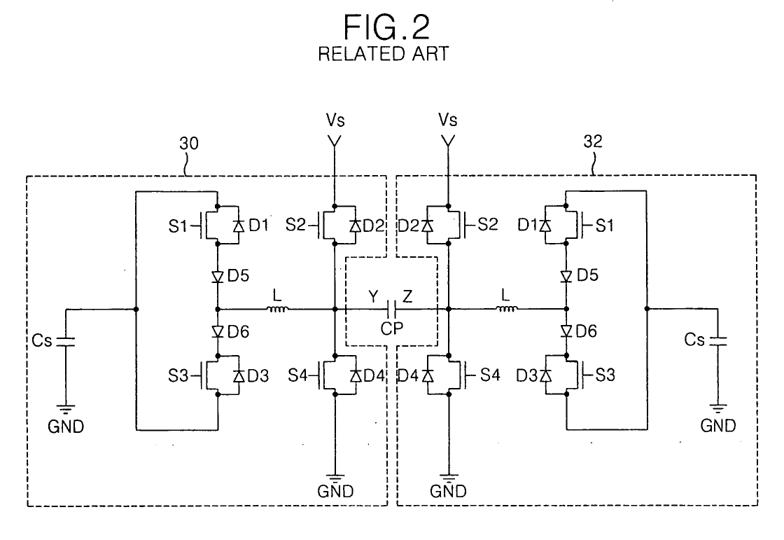

FIG. 3 is a timing diagram and a waveform diagram representing an ON/OFF timing of each switch shown in FIG. 2 and an output waveform of the panel capacitor;

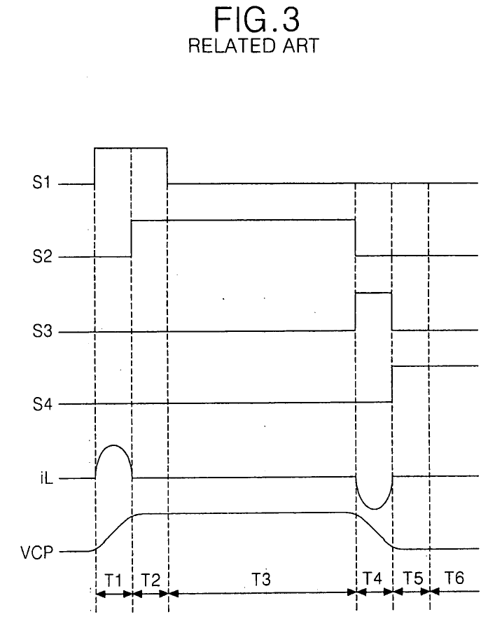

FIG. 4 is a circuit diagram of another conventional energy recovering apparatus;

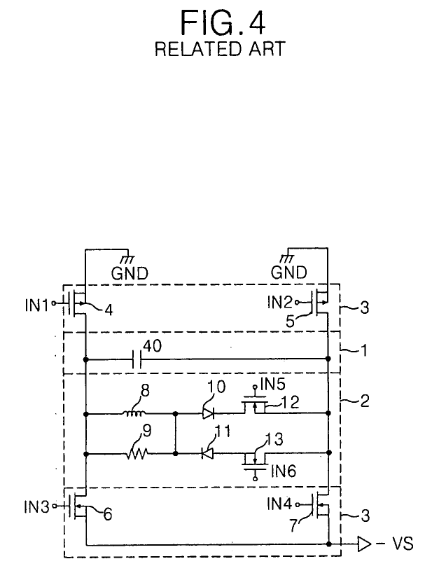

FIG. 5 is a timing diagram and a waveform diagram representing an ON/OFF timing of each switch shown in FIG. 4 and an output waveform of the panel capacitor;

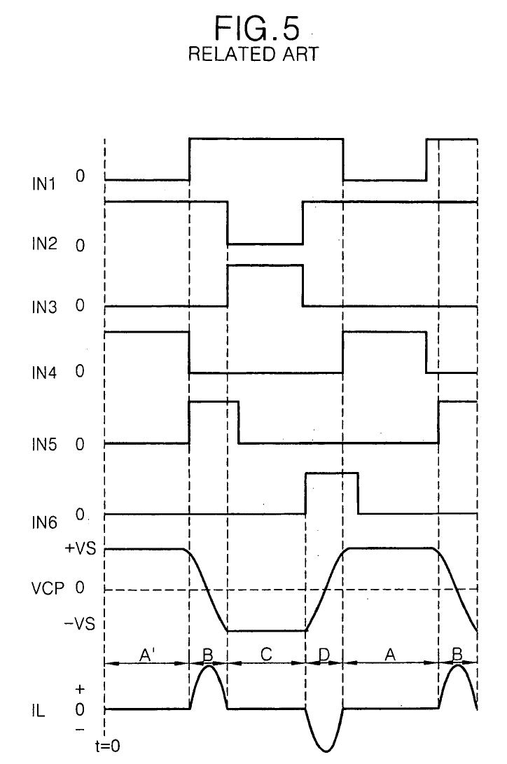

FIG. 6A is a circuit diagram representing an ON/OFF state and a current path of the switching device in the A′ period shown in FIG. 5;

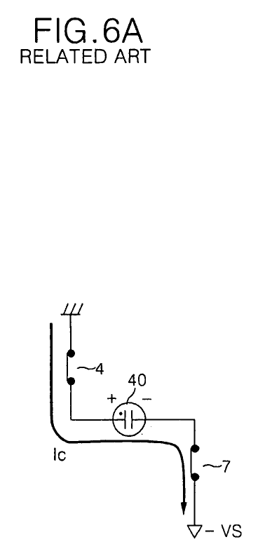

FIG. 6B is a circuit diagram representing an ON/OFF state and a current path of the switching device in the B period shown in FIG. 5;

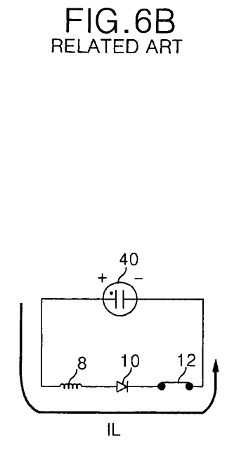

FIG. 6C is a circuit diagram representing an ON/OFF state and a current path of the switching device in the C period shown in FIG. 5;

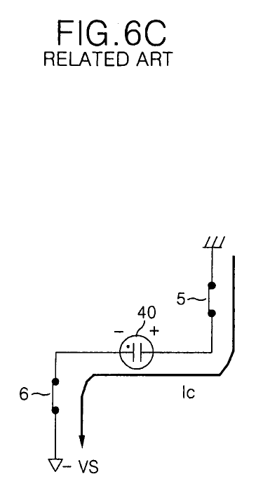

FIG. 6D is a circuit diagram representing an ON/OFF state and a current path of the switching device in the D period shown in FIG. 5;

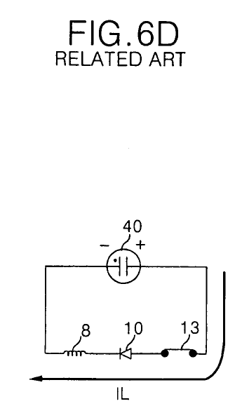

FIG. 6E is a circuit diagram representing an ON/OFF state and a current path of the switching device in the A period shown in FIG. 5;

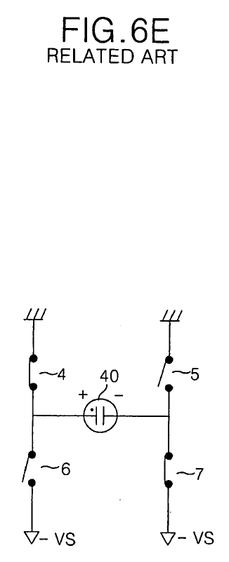

FIG. 7 is a circuit diagram of an energy recovering apparatus of a plasma display panel according to one of the embodiments of the present invention;

FIG. 8 is a timing diagram and a waveform diagram representing an ON/OFF timing of each switch and an output waveform of the panel capacitor in the energy recovering apparatus of the plasma display panel according to a first embodiments shown in FIG. 7;

FIG. 9 is a circuit diagram representing an ON/OFF state and a current path of the switching device in the T0 period shown in FIG. 8;

FIG. 10 is a circuit diagram representing an ON/OFF state and a current path of the switching device in the T1 period shown in FIG. 8;

FIG. 11 is a circuit diagram representing an ON/OFF state and a current path of the switching device in the T2 period shown in FIG. 8;

FIG. 12 is a circuit diagram representing an ON/OFF state and a current path of the switching device in the T3 period shown in FIG. 8;

FIG. 13 is a timing diagram and a waveform diagram representing an ON/OFF timing of each switch and an output waveform of the panel capacitor in the energy recovering apparatus of the plasma display panel according to one of the embodiments shown in FIG. 7;

FIG. 14 is a circuit diagram representing an ON/OFF state and a current path of the switching device in the TA interval of the T0 period shown in FIG. 13;

FIG. 15 is a circuit diagram representing an ON/OFF state and a current path of the switching device in the TB interval of the T0 period shown in FIG. 13;

FIG. 16 is a circuit diagram representing an ON/OFF state and a current path of the switching device in the T1 period shown in FIG. 13;

FIG. 17 is a circuit diagram representing an ON/OFF state and a current path of the switching device in the TC interval of the T2 period shown in FIG. 13;

FIG. 18 is a circuit diagram representing an ON/OFF state and a current path of the switching device in the TD interval of the T2 period shown in FIG. 13; and

FIG. 19 is a circuit diagram representing an ON/OFF state and a current path of the switching device in the T3 period shown in FIG. 13.

### DETAILED DESCRIPTION OF PREFERRED EMBODIMENTS

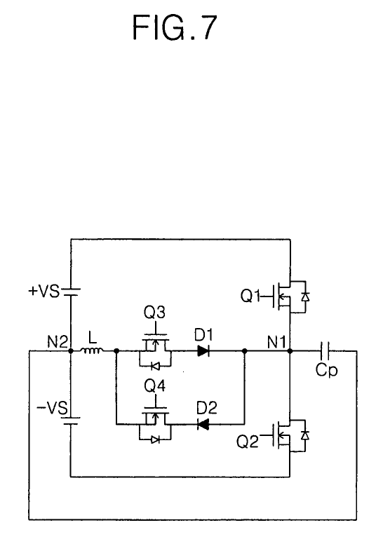

Referring to FIG. 7, there is shown an energy recovering apparatus of a plasma display panel (PDP) according to one of the first embodiments of the present invention.

A panel capacitor Cp is equivalently formed at first and second electrodes of the PDP. A first sustain voltage source +VS provides a first polarity of voltage +VS, and a second sustain voltage source −VS provides a second polarity of voltage −VS. A first switch Q1 is connected between the first sustain voltage source +VS and a first electrode of the panel capacitor Cp, and a second switch Q2 is connected between the second sustain voltage source −VS and the first electrode. An inductor L is connected between a first node N1 positioned between the first and second switches Q1 and Q2 and a second node N2 positioned between the first and second voltage source +VS and −VS. Third and fourth switches Q3 and Q4 is connected, in parallel, between the inductor L and the first node N1.

The first sustain voltage source +VS generates a positive sustain voltage +VS supplied to the panel capacitor Cp. The second sustain voltage source −VS generates a negative sustain voltage −VS supplied to the panel capacitor Cp.

Each of the first and second switches Q1 and Q2 is connected, in parallel, to one end of the panel capacitor Cp, that is, the first node (i.e., the first electrode). Each of the third and fourth switches Q3 and Q4 is connected, in parallel, between the inductor L and the first node N1 in a mutually different direction. The inductor L is connected, via the third and fourth switches Q3 and Q4, to the panel capacitor Cp to recover an energy by an LC natural resonance provided from itself and the panel capacitor Cp, and again applies the recovered energy to the panel capacitor Cp.

Preferably, first to fourth switches Q1 to Q4 are sequentially turned on to thereby control a flow of current. A diode is connected, in parallel, to each of the first to fourth switches Q1 to Q4. The diodes can be used as internal diodes of the first to fourth switches Q1 to Q4. Alternatively, the diodes may be used as external diodes thereof. Each of the first to fourth switches Q1 to Q4 employs any one of semiconductor switching devices such as a metal oxide semiconductor field-effect transistor (MOSFET), an insulated gate bipolar transistor (IGBT), a silicon-controlled rectifier (SCR), a bipolar junction transistor (BJT) and a high electron mobility transistor (HEMT), etc. Further, other switches and/or configurations are possible, which are illustrated in co-pending application Ser. Nos. 10/416,286 filed May 9, 2003, (OP3095) filed ______, and (OP3096) filed ______, assigned to the same Assignee, whose entire disclosure is incorporated herein by reference.

Meanwhile, a first diode D1 for shutting off a backward current from the panel capacitor Cp is connected between the third switch S3 and the first node N1 while a second diode D2 for shutting off a backward current from the fourth switch Q4.

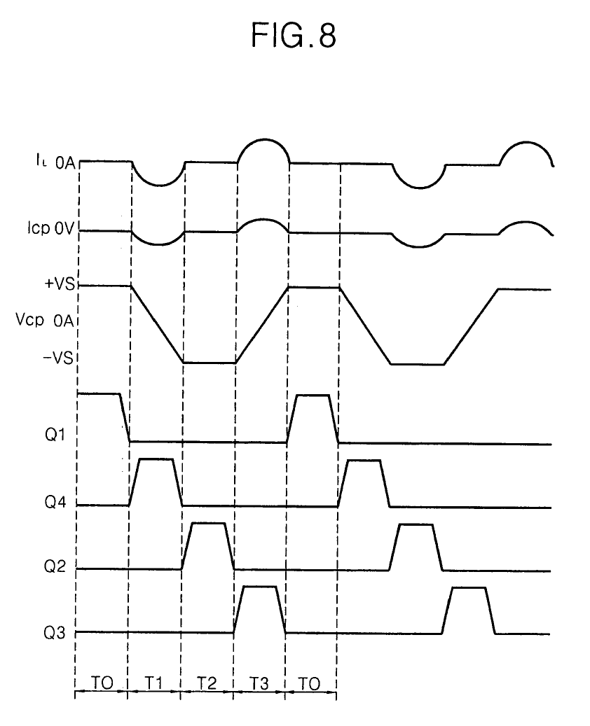

FIG. 8 is a timing diagram and a waveform diagram representing an ON/OFF timing of each switch shown in FIG. 7 and a voltage applied to the panel capacitor.

An energy recovering apparatus and method according to one of the embodiments will be described in conjunction with FIGS. 7-12.

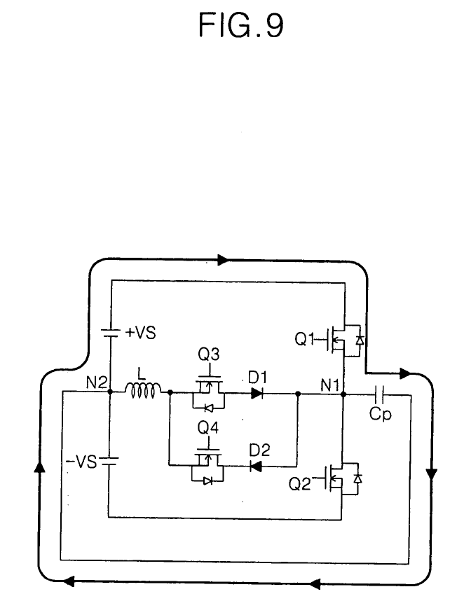

First, in a T0 period, the first switch Q1 of the first to fourth switches Q1 to Q4 is preferably turned on, to form a current path extending from the first sustain voltage source +VS, via the first switch Q1, the first node N1, the panel capacitor Cp and the second node N2, into the first sustain voltage +VS, as shown in FIG. 9. Accordingly, the panel capacitor Cp charges a sustain voltage +VS supplied from the first sustain voltage source +VS. Thus, the panel capacitor Cp keeps a positive sustain voltage +VS.

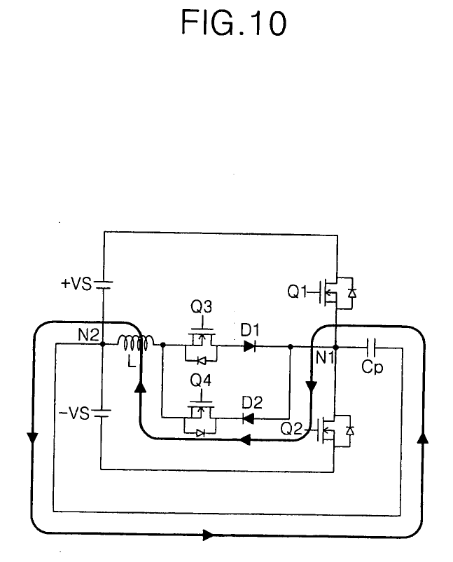

In a T1 period, the first switch Q1 is turned off while the fourth switch Q4 is preferably turned on, to form a current path extending from the panel capacitor Cp, via the first node N1, the second diode D2, the fourth switch Q4 and the inductor L, into the panel capacitor Cp, as shown in FIG. 10. Accordingly, the inductor L recovers an energy charged in the panel capacitor Cp with the aid of an LC natural resonance provided by itself and the panel capacitor Cp. Thus, a voltage of the panel capacitor Cp falls from the positive sustain voltage +VS into the negative sustain voltage −VS.

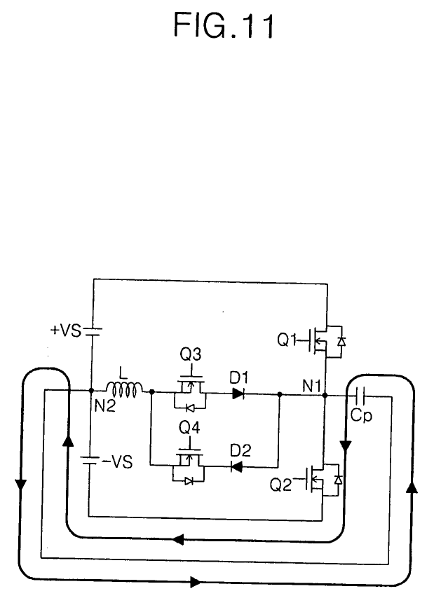

In a T2 period, the fourth switch Q4 is turned off while the second switch Q2 only is turned on, to thereby form a current path extending from the second sustain voltage source −VS, via the second node N2, the panel capacitor Cp, the first node N1 and the second switch Q2, into the second sustain voltage source −VS, as shown in FIG. 11. Accordingly, the panel capacitor Cp receives a negative sustain voltage −VS from the second sustain voltage −VS to keep the negative sustain voltage −VS.

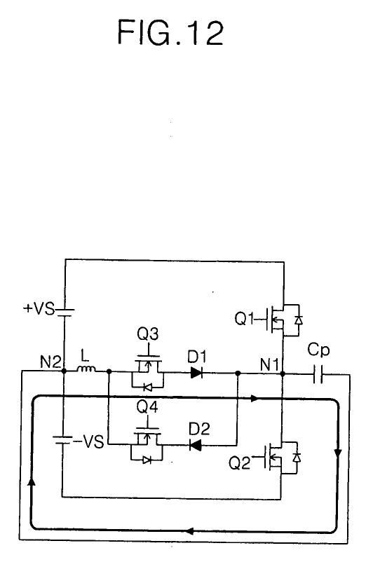

In a T3 period, the second switch Q2 is turned off while the third switch Q3 is preferably turned on, to thereby form a current path extending from the panel capacitor Cp, via the second node N2, the inductor L, the third switch S3, the first diode D1 and the first node N1, into the panel capacitor Cp as shown in FIG. 12. Accordingly, the inductor L recovers an energy charged in the panel capacitor Cp with the aid of an LC natural resonance provided by itself and the panel capacitor Cp, and again applies the recovered energy to the panel capacitor Cp. Thus, a voltage of the panel capacitor Cp nses from the negative sustain voltage −VS into the positive sustain voltage +VS.

Such T0 to T3 periods are periodically repeated to thereby apply an alternating current sustain pulse Vcp to the panel capacitor Cp. The AC driving pulse Vcp applied to the first and second electrodes Y and Z of the PDP is generated with periodically repeating the above-mentioned T0 to T3 periods.

As described above, such an energy recovering apparatus and method of the PDP according to the first embodiment of the present invention uses an LC natural resonance provided by the inductor L and the panel capacitor Cp to recover an energy charged in the panel capacitor Cp, and again applies the recovered energy to the panel capacitor. Thus, the energy recovering apparatus and method of the PDP according to this embodiment can preferably use one inductor and one switching device between the first electrode Y and the second electrode Zas the energy-recovering current path of the panel capacitor. Hence, a conduction loss and a switching loss of the semiconductor device is minimized.

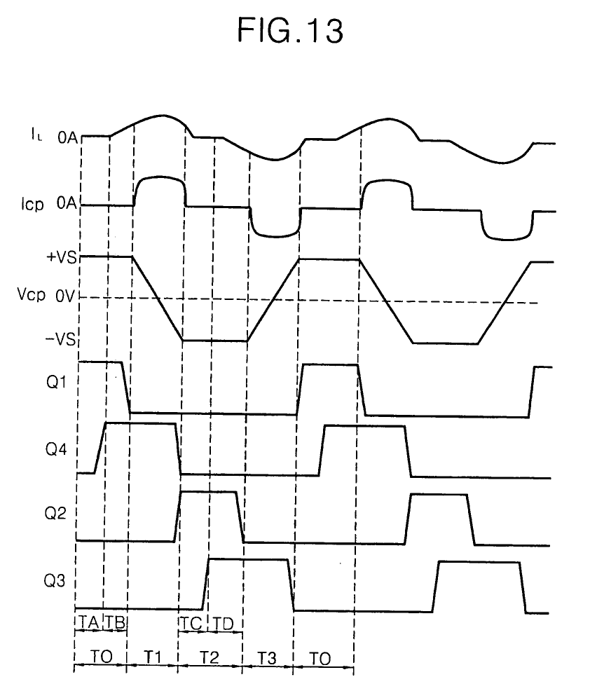

FIG. 13 is a timing diagram and a waveform diagram representing an ON/OFF timing of each switch shown in FIG. 7 and a voltage applied to the panel capacitor.

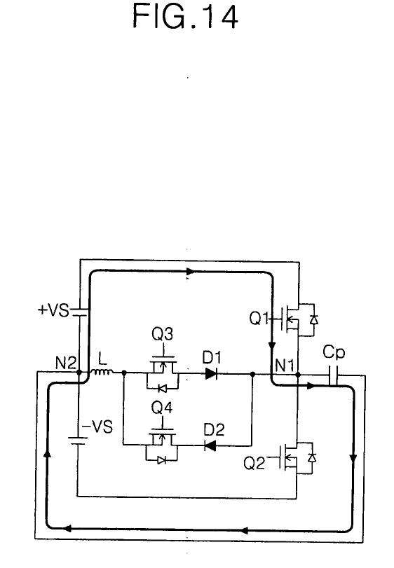

An energy recovering apparatus and method according to the another embodiment will be described in conjunction with FIGS. 7, 13 and 14-19.A T0 period is divided into a TA interval when the first switch Q1 is turned on, and a TB interval when both the first and fourth switches Q1 and Q4 are turned on. In the TA interval of the T0 period, the first switch Q1 of the first to fourth switches Q1 to Q4 is preferably turned on, to form a current path extending from the first sustain voltage source +VS, via the first switch Q1, the first node N1, the panel capacitor Cp and the second node N2, into the first sustain voltage +VS, as shown in FIG. 14. Accordingly, the panel capacitor Cp charges a sustain voltage +VS supplied from the first sustain voltage source +VS.

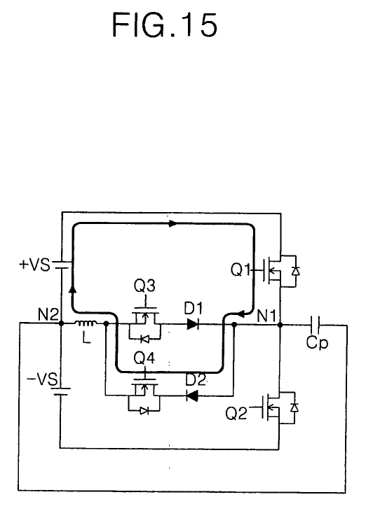

In the TB interval of the T0 period, the fourth switch Q4 is turned on in a state in which the first switch Q1 has been turned on, to form a current path extending from the first sustain voltage source +VS, via the first switch Q1, the first node N1, the second diode D2, the fourth switch Q4, the inductor L and the second node N2, into the first sustain voltage +VS. Accordingly, the sustain voltage +VS charged in the panel capacitor Cp is kept, as shown in FIG. 14, and the inductor L charges a current IL from the first sustain voltage source +VS, as shown in FIG. 15.

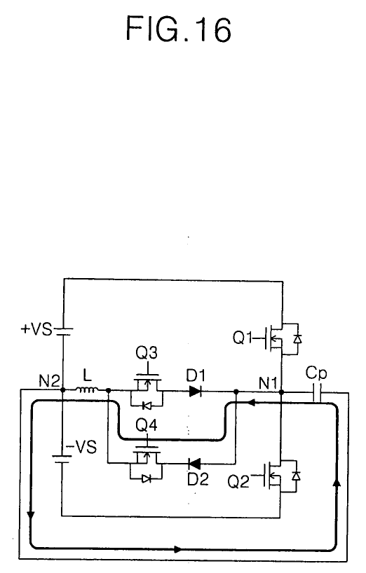

In a T1 period, the fourth switch Q4 keeps a turned-on state while the first switch Q1 is turned off, to form a current path extending from the inductor L, via the panel capacitor Cp, the first node N1, the second node D2 and the fourth switch Q4, into the inductor L, as shown in FIG. 16. Thus, the inductor L recovers and supplies a current charged in the panel capacitor Cp with the aid of an inverse voltage generated by a reverse electromotive force when the first switch Q1 is turned off. Accordingly, the panel capacitor Cp falls into a negative sustain voltage −VS by an inverse voltage supplied from the inductor L. The inductor L recovers and supplies a current charged in the panel capacitor Cp using the inverse voltage in this manner, thereby obtain a rapid falling slope of the sustain voltage waveform.

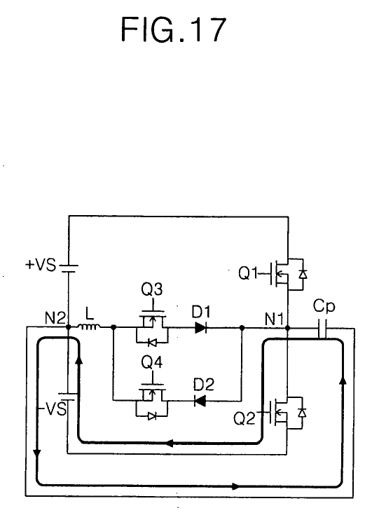

A T2 period is divided into a TC interval when only the second switch Q2 only is turned on and a TD interval when both the second and third switches Q2 and Q3 are turned on. In the TC interval of the T2 period, the second switch Q2 of the first to fourth switches Q1 to Q4 is turned on, to thereby form a current path extending from the second sustain voltage source −VS, via the second node N2, the panel capacitor Cp, the first node N1 and the second switch Q2, into the second sustain voltage −VS, as shown in FIG. 17. Thus, the panel capacitor Cp receives a negative sustain voltage −VS from the second sustain voltage source −VS to keep the negative sustain voltage −VS of the T1 period.

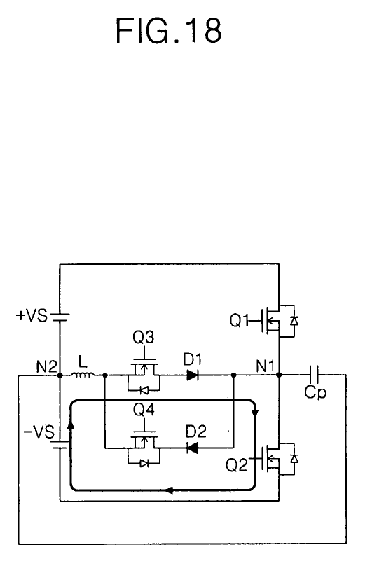

In the TD interval of the T2 period, the third switch Q3 is turned on in a state in which the second switch Q2 has been turned on, to thereby form a current path extending from the second sustain voltage source −VS, via the second node N2, the inductor L, the third switch Q3, the first diode D1, the first node N1 and the second node Q2, into the second sustain voltage source −VS. Thus, the negative sustain voltage −VS charged in the panel capacitor Cp is kept, as shown in FIG. 17, and the inductor L charges a current IL from the second sustain voltage source −VS, as shown in FIG. 18.

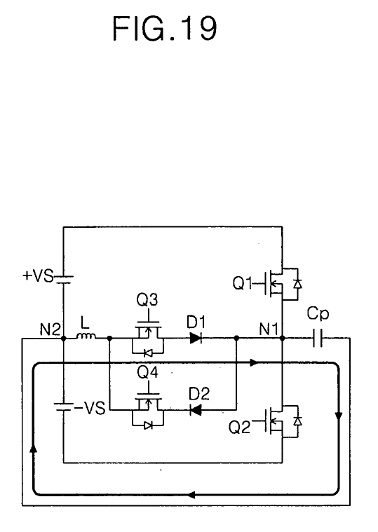

In a T3 period, the third switch Q3 is turned on while the second switch Q2 is turned off, to form a current path extending from the inductor L, via the third switch Q3, the first diode D1, the first node N1, the panel capacitor Cp and the second node N2, into the inductor L, as shown in FIG. 19. Thus, the inductor L recovers and supply a current charged in the panel capacitor Cp using an inverse voltage generated by a reverse electromotive force when the second switch Q2 is turned off Accordingly, the panel capacitor Cp rises into the sustain voltage +VS by the inverse voltage supplied from the inductor L. The current charged in the panel capacitor Cp is recovered and supplied with the aid of the inverse voltage derived from the inductor L, thereby obtaining a rapid rising slope of the sustain voltage waveform.

Such T0 to T3 periods are periodically repeated to thereby apply an alternating current sustain pulse to the panel capacitor Cp. The AC driving pulse Vcp applied to the first and second electrodes Y and Z of the PDP is generated with periodically repeating the above-mentioned T0 to T3 periods.

Such an energy recovering apparatus and method of the PDP according to the embodiments of the present invention charges an energy into the inductor L in the course of supplying the sustain voltage +VS to the panel capacitor Cp, and recovers and supplies an energy charged in the panel capacitor Cp using an inverse voltage upon recovering of the energy. Accordingly, it is possible to obtain rapid rising and falling slopes of the sustain waveform upon recovering of the energy.

As described above, the energy recovering apparatus and method of the PDP according to the embodiments of the present invention charges an energy into the inductor in the course of supplying the sustain voltage +VS to the panel capacitor, and recovers and supplies an energy charged in the panel capacitor using an inverse voltage upon recovering of the energy. Accordingly, it is possible to obtain rapid rising and falling slopes of the sustain waveform upon recovering of the energy.

Furthermore, the energy recovering apparatus and method of the PDP according to the embodiments of the present invention has an advantage in that it can be configured at any one side of the first and second electrodes of the PDP. Also, a switching device exists in the sustain current path, so that it is possible to minimize a conduction loss. In addition, the energy recovering apparatus of the PDP according to the embodiments of the present invention uses four switching devices and two diodes, thereby reducing power consumption.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A plasma display, comprising:
a panel;
at least one voltage source for supplying a sustain voltage to the panel;
an inductor for recovering an energy stored in the panel by a resonance phenomenon such that the recovered energy is reusable for driving the panel; and
first and second switches arranged, in parallel, between the inductor and the panel.

2. The plasma display as claimed in claim 1, wherein at least one voltage source comprises:
a first voltage source for charging the panel to a first polarity; and
a second voltage source for charging the panel to a second polarity different from the first polarity.

3. The plasma display as claimed in claim 2, further comprising:
a third switch for forming a conductive path between the first voltage source and the panel; and
a fourth switch for forming a conductive path between the second voltage source and the panel.

4. The plasma display as claimed in claim 1, further comprising:
a first diode connected between the first switch and the panel; and
a second diode connected between the second switch and the panel.

5. An energy recovering method for a plasma display, comprising:
forming a first electrically conductive path between a first voltage source and the plasma display using a first switch;
forming a second electrically conductive path between a second voltage source and the plasma display using a second switch;
forming a third electrically conductive path between the inductor and the plasma display using a third switch; and
forming a fourth electrically conductive path between the inductor and the plasma display using a fourth switch connected, in parallel, to the third switch.

6. The energy recovering method as claimed in claim 5,
shutting off a backward current from the plasma display using a first diode connected between the third switch and the plasma display; and
shutting off a backward current from the fourth switch using a second diode connected between the fourth switch and the plasma display.

7. A plasma display comprising:
a display having a plurality of electrodes and having a corresponding display capacitance between first and second nodes;
an inductor coupled to the second node and a third node;
a first switch coupled between the first and third nodes; and
a second switch coupled between the first and third nodes, the first and second switches being formed in parallel, wherein
a first current path is formed via the panel capacitance, the second node, the inductor, the third node, the first switch and the first node, and
a second current path is formed via the panel capacitance, the first node, the second switch, the third node, the inductor and the second node.

8. The plasma display of claim 7, wherein the direction of the first and second current paths are opposite directions.

9. The plasma display of claim 7, wherein the first current path charges the display capacitance from a first potential to a second potential and the second current path discharges the display capacitance from the second potential to the first potential.

10. The plasma display of claim 9, wherein the display capacitance is charge or discharged based on an LC resonance frequency.

11. The plasma display of claim 10, wherein the display capacitance is charged or discharged based on a non-LC resonance frequency.

12. The plasma display of claim 11, wherein an energy of the inductor current is increased prior to the discharging of the display capacitance or the energy is decreased prior to charging of the display capacitance.

13. The plasma display of claim 11, wherein during charging or discharging, the display capacitance is clamped before a stored energy of inductor reaches zero.

14. The plasma display of claim 7, wherein the first current path further comprises a diode coupled between the first switch and the first node.

15. The plasma display of claim 7, wherein the second current path further comprises a diode coupled between the first node and the second switch.

16. The plasma display of claim 7, further comprising:
a first clamping circuit coupled between the first and second nodes; and
a second clamping circuit coupled between the first and second nodes.

17. The plasma display of claim 16, wherein the first clamping circuit comprises a third switch coupled to the first node and a first potential via a first conductive path, and the second clamping circuit comprises a fourth switch coupled to the first node and a second potential via a second conductive path, wherein the first and second potentials are different.

18. The plasma display of claim 17, wherein the first potential is provide by a positive power source, and the second potential is provided by a negative power source.

19. In display panels having panel electrodes and corresponding panel capacitance between first and second nodes, an inductor coupled to the second node and a third node, a first switch coupled between the first and third nodes and a second switch coupled between the first and third nodes, the first and second switches being formed in parallel, an energy efficient method of driving said display panels through the inductor coupled to the panel electrodes, comprising:
(a) discharging the panel capacitance through said inductor initially while storing energy in said inductor until the magnitude of the inductor current reaches a maximum through a first current path formed via the panel capacitance, the second node, the inductor, the third node, the first switch and the first node, and secondly charging the panel capacitance through said inductor while removing the stored energy from said inductor until the inductor current reaches zero or before zero via the first current path; and
(b) discharging the panel capacitance through said inductor initially while storing energy in said inductor until the magnitude of the inductor current reaches a maximum through a second current path formed via the panel capacitance, the first node, the second switch, the third node, the inductor and the second node, and secondly charging the panel capacitance through said inductor while removing the stored energy from said inductor until the inductor current reaches zero or before zero through the second current path.

20. The method of claim 19 further comprising:
maintaining panel capacitance after step (a) by a first clamping circuit having a third switch coupled to the first node and a first potential via a first conductive path; and
maintaining the panel capacitance after step (b) by a second clamping circuit having a fourth switch coupled to the first node and a second potential via a second conductive path.

21. The method of claim 20, wherein storing and removing of stored energy in the inductor is based on an LC resonance frequency if the inductor current reaches zero.

22. The method of claim 20, wherein charging and discharging of the panel capacitance is not based on an LC resonance frequency via the first and second clamping circuit clamping the panel capacitance prior to the inductor current reaching zero.

23. The method of claim 22, wherein the first and second clamping circuits clamp the panel capacitance prior to the inductor current reaches zero.

24. The method of claim 22, wherein the second clamping circuit pre-stores energy in the inductor prior to step (a) and the first clamping circuit pre-stores energy in the inductor prior to step (b).

25. A plasma display panel driver circuit comprising:
a panel inter-electrode capacitor provided between at least one of a plurality of scanning electrodes and a plurality of sustain electrodes of a panel;
a charging/discharging circuit connected in series with said panel inter-electrode capacitor and between first and second nodes,
a clamping circuit having first and second switches for clamping a terminal voltage across the panel inter-electrode capacitor to a first power source voltage level and to a second power source voltage level, said first switch being connected in series between the first node and the first power source voltage level, said second switch being connected in series between said first node and the second power source voltage level, said inter-electrode capacitor being connected in series to the first and second nodes and said charging/discharging circuit and said clamping circuit being coupled in parallel between the first and second nodes, wherein
said charging/discharging circuit comprises a pair of switches coupled in parallel to each other between the first anode and a third node and an inductive coil coupled in series between the second and third nodes.

26. The plasma display panel driver circuit of claim 25, wherein each of the pair of switches comprises a first transistor and a diode, and the pair of switches provide opposite current paths.

27. The plasma display panel driver circuit of claim 25, wherein the inter-electrode capacitor is charged/discharged based on an LC resonant frequency of the inductor coil and the inter-electrode capacitor.

28. The plasma display panel driver circuit of claim 25, wherein the inter-electrode capacitor is charge/discharged based on a non-LC resonant frequency of the inductor coil and the inter-electrode capacitor.

29. The plasma display panel driver circuit of claim 28, wherein the clamping circuit clamps the inter-electrode capacitor one of the first and second power source voltage level prior to an energy of the inductor coil reaching zero.

30. The plasma display panel driver circuit of claim 29, wherein the clamping circuit increases an energy of the inductor coil prior to charging/discharging of the inter-electrode capacitor.

31. The plasma display panel driver circuit of claim 25, wherein each of said first and second switches comprises a transistor.
